(19) United States
(12) Patent Application Publication
(10) Pub. No.: US 2009/0162158 A1
(43) Pub. Date: Jun. 25, 2009

(54) Hand Held Portable Drill Leverage Unit

(75) Inventors: Michael Glodowski, Meridian, ID (US); Steve A. Hatten, Boise, ID (US); Calvin Allen, Boise, ID (US); Nathan Kems, Boise, ID (US)

Correspondence Address: QUICKPATENTS, INC., 32861 CALLE PERFECTO, SUITE A, SAN JUAN CAPISTRANO, CA, 92675, US

(73) Assignee: Michael Glodowski, Meridian, ID (US)

(21) Appl. No.: 12/177,695

(22) Filed: Jul. 22, 2008

Related U.S. Application Data
(60) Provisional application No. 60/962,001, filed on Jul. 24, 2007.

(51) Int. Cl. B23B 47/00

(52) U.S. Cl. 408/136

(57) ABSTRACT

A leveraging apparatus for a drill is disclosed for drilling a workpiece. The apparatus includes a bar body that preferably has a plurality of attachment means there along. A carriage is adapted to slidably receive the bar body and further includes a forward side, and a lower side for mounting with a drill clamping means. An elongated handle is pivotally connected at a distal end thereof proximate the forward side of the carriage. The handle is pivotally, and preferably selectively, attached to the bar body. The clamping means may include a bracket having an aperture therein for selectively receiving the drill therein. A foot means extending away from the bar body is fixed thereto with a bar body attachment means. The foot means is used to brace the workpiece while the handle is used to move the carriage with respect to the bar body to drill the workpiece.

### CROSS-REFERENCE TO RELATED APPLICATIONS

This application claims the benefit of U.S. Provisional Patent Application 60/962,001, filed on Jul. 24, 2008, and incorporated herein by reference.

### STATEMENT REGARDING FEDERALLY SPONSORED RESEARCH AND DEVELOPMENT

Not Applicable.

### FIELD OF THE INVENTION

This invention relates to tools, and more particularly to a tool for drilling.

### DISCUSSION OF RELATED ART

When using a typical power drill to drill holes in a workpiece, an operator must not only apply pressure against the workpiece to force the rotating drill bit into the workpiece, but he must also maintain a consistent angle of the drill so that the resulting hole is the proper size and shape. When torque of the drill is experienced, if the operator does not adequately resist such torque forces the hole will not be drilled to the proper size since the drill bit angle may change, rendering the hole oblong instead of circular. Further, such torque forces can cause the drill to slip out of the operator's hand, or jerk the operator's hand dangerously if the drill bit “grabs” the workpiece.

Further, depending on the material being cut and the sharpness of the drill bit, the operator may have to exert significant force against the drill and workpiece, which over time can cause operator fatigue. If there are a relatively large number of holes to be drilled in the workpiece, the operator may become fatigued before all of the intended holes are drilled.

Several prior art devices have been designed to overcome some of these aforementioned drawbacks. For example, the following patents all disclose different devices for increasing the leverage to the operator of such drilling operations:

| Patent Number | Issue Date | Inventor(s) |
|---|---|---|
| 6,494,650 | Dec. 17, 2002 | Maecker |
| 5,863,160 | Jan. 26, 1999 | Havener |
| 5,863,158 | Jan. 26, 1999 | Foshee, Jr. et al. |
| 5,820,317 | Oct. 13, 1998 | Van Troba |
| 4,168,926 | Sep. 25, 1979 | Belcourt |
| 4,136,579 | Jan. 30, 1979 | Robinson et al. |

However, such devices do not provide means for mitigating or absorbing torque forces against the drill, and thus the operator must still provide some torque stabilizing effort when using such devices. Further, several of these prior art devices require a separate backstop or support surface which might not always be conveniently available, thereby rendering such devices useless.

Other prior art devices, such as those disclosed in U.S. Pat. No. 6,666,282 to Merrick on Dec. 23, 2003, and US Patent Application 2005/0214085 to Owens on Sep. 29, 2005, attempt to not only increase the leverage afforded to the operator of such devices, but also to reduce torque forces experienced by the operator against the drill. However, such devices must also have a backstop surface to press against, which might not always be at hand.

U.S. Pat. No. 4,655,649 to Itzov et al. on Apr. 7, 1987, teaches a drill press type device that includes a carriage for holding the drill and a lever arm for moving the carriage along a vertical column. Such a device improves the leverage afforded to the operator as well as mitigates the torque forces applied to the drill by the workpiece. However, such a device requires a relatively large carriage assembly and vertical column, and a relatively complex gearing arrangement, resulting in a heavy tool that is difficult to transport and use. Further, such a device is relatively expensive due to the number of components.

U.S. Pat. No. 4,442,905 to Agoston on Apr. 17, 1984, teaches a lighter-weight drill leveraging assembly. However, such a device also requires a backing surface to be used, and positions an actuator lever in an awkward location behind the drill.

Glodowski's previous patent, U.S. Pat. No. 7,226,252, issued on Jun. 5, 2007, teaches a drill leverage unit that solves many of the aforementioned drawbacks of the prior art. However, such a device includes a relatively complicated mechanism for maintaining a carriage on a bar body. Such a mechanism includes a handle-actuated lever that, when actuated, allows the carriage to slide back away from the workpiece. Due to such complexity, such a device is relatively expensive, relatively difficult to manufacture and use, and is prone to failure due to its relatively large number of moving parts. Further, such a device may not be easily installed on a stationary support, as can sometimes be desired, particularly when drilling a large number of holes or workpieces.

Therefore, there is a need for a device that not only allows the user to provide leveraged power to the workpiece, but also mitigates or absorbs torque forces experienced by the drill. Such a needed device would be relatively simple to manufacture, transport to a job site, and use. Further, such a needed invention would allow relatively quick mounting thereof to a workbench or other substantially fixed support base, and would be easily reversible to allow the drill to operate in either of two opposing directions as desired. Such a needed apparatus would also be relatively easy to mount to an existing power drill, and would be easily adjusted to initially bring the drill into close proximity to the workpiece. The present invention accomplishes these objectives.

### SUMMARY OF THE INVENTION

The present device is a leveraging apparatus for a drill for drilling a workpiece. The apparatus includes an elongated, rigid bar body that preferably has a plurality of attachment means there along. A carriage is adapted to slidably receive the bar body and further includes a forward side and a lower side for mounting with a drill clamping means. An elongated handle is pivotally connected at a distal end thereof proximate the forward side of the carriage. The handle is pivotally, and preferably selectively, attached to the bar body.

The clamping means may include a bracket having an aperture therein for selectively receiving the bearing block fixedly therein. Further, the clamping means preferably includes a slot for receiving a fixing means, such as a fastening knob.

A foot means is fixed to the bar body with a bar body attachment means. The foot means is preferably a rigid Y-shaped member, but may take other shapes as desired, extending away from the distal side of the bar body. As such, the Y-shaped member is selectively locked to, and at fixed at a predetermined angle with, the bar body.

In use, with the drill fixed to the drill clamping means and with the workpiece braced against the foot means, the carriage can be moved toward the workpiece and pivotally secured to the bar body at one or more of the attachment means. A proximal end of the handle is then moved upward to force the drill downward into the workpiece to drill the workpiece.

The present invention is a device that not only allows the user to provide leveraged power to the workpiece, but also mitigates or absorbs torque forces experienced by the drill. The present device is relatively simple to manufacture, transport to a job site, for example, and use repeatedly. Further, the present apparatus allows relatively quick mounting thereof to an existing workbench or other substantially fixed support base, and is easily reversible to allow the drill to operate in either of two opposing directions as desired. The present apparatus is also relatively easy to mount to an existing power drill, and is easily adjusted to initially bring the drill into close proximity to the workpiece. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention;

FIG. 2 is a perspective view of the invention, illustrating an alternate orientation of the workpiece and a carriage of the invention;

FIG. 3 is a perspective view of the invention, taken generally from a front side thereof,

FIG. 4 is a perspective view of bearing block and shaft of the invention, for use with a drill;

FIG. 5 is a perspective view of a drill clamp of the invention;

FIG. 6 is a perspective view of a spacer block of the invention;

FIG. 7 is a perspective view of an alternate version of a drill clamping means; and

FIG. 8 is a front elevational view of the invention.

### DETAILED DESCRIPTION OF THE PREFERRED EMBODIMENT

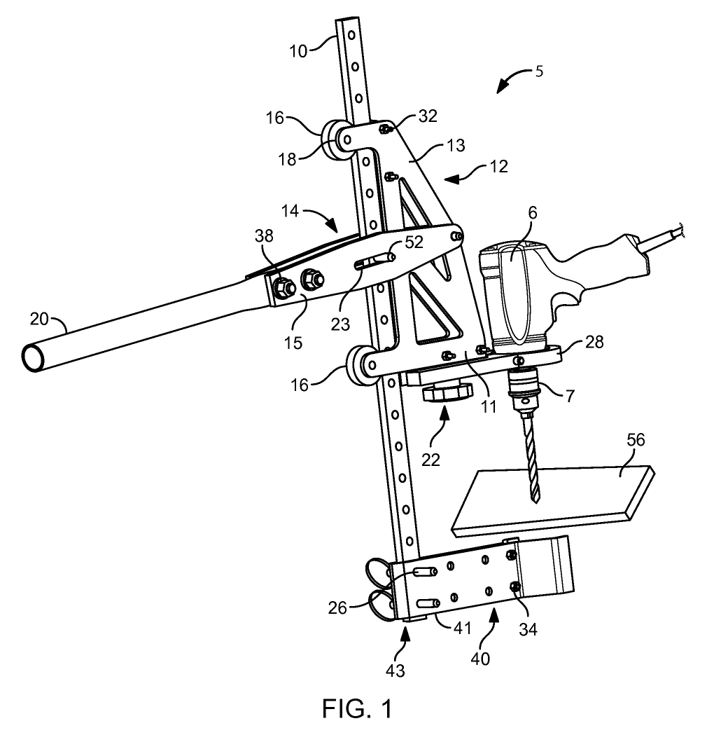

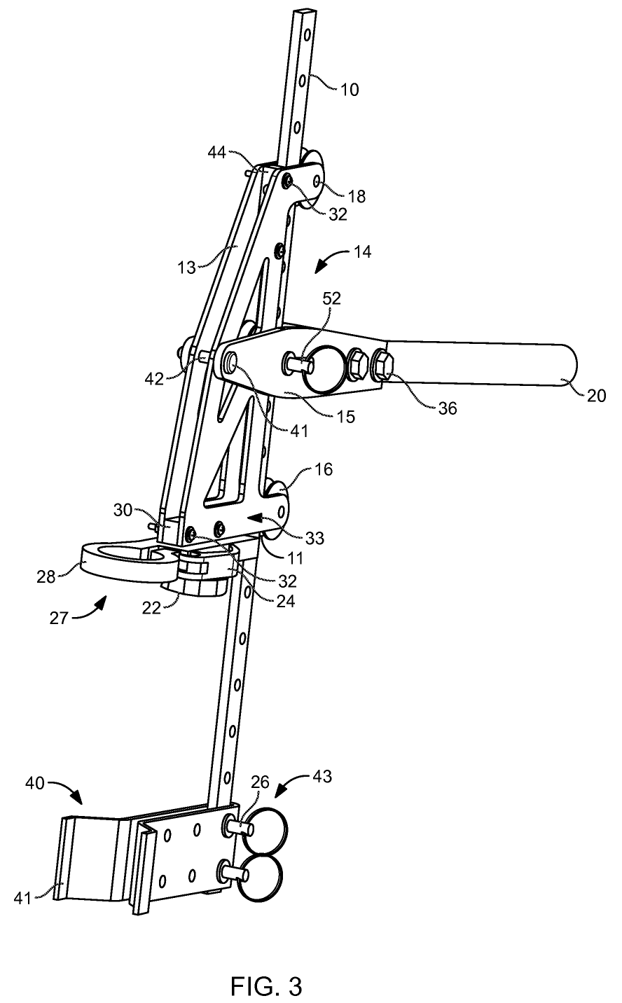

FIGS. 1 and 3 illustrate a leveraging apparatus 5 for a drill 6 for drilling a workpiece 56. The apparatus 5 includes an elongated, rigid bar body 10 that preferably has at least a proximal side 120, a distal side 130, and two lateral sides 140. The lateral sides 140 both preferably have a plurality of attachment apertures 150 therethrough. Alternately, the bar body 10 may have notches or other suitable attachment means (not shown). The attachment apertures 150 or other attachment means are preferably evenly spaced along the bar body 10. The bar body 10 may be made from any rigid metal stock material, or any suitably durable and rigid plastic or epoxy resin material.

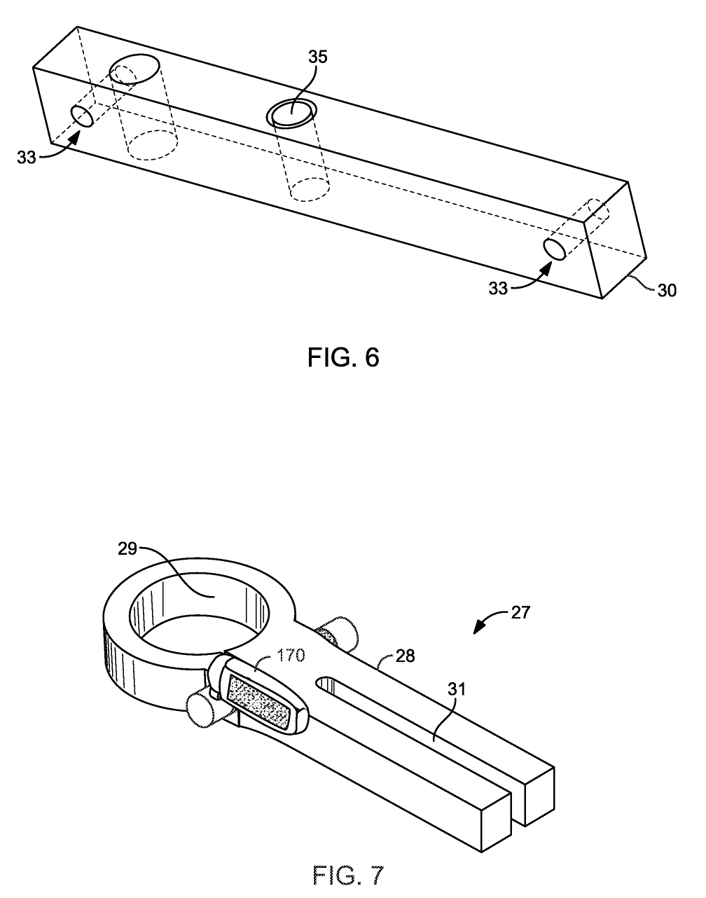

A carriage 12 is adapted to slidably receive the bar body 10 proximate a rear side 100 thereof. Preferably the carriage 12 is adapted to slidably receive the bar body 10 between at least two rollers 16 each rotationally fixed proximate the rear side 100 of the carriage 12 with a roller pin 18. Alternately, the carriage 12 may include a C-shaped slot (not shown) for slidably capturing the bar body 10. Such a C-shaped slot may be formed by fixing a plurality of L-shaped brackets (not shown) to the carriage 12, for example. Alternately, the carriage 12 includes a pair of carriage plates 13 for capturing the bar body 10 and each roller 16 therebetween. The carriage 12 further includes a forward side 110, and a lower side 11 for mounting with a drill clamping means 27. The carriage 12 may be formed by fixing the two carriage plates 13 together with a spacer block 30 (FIG. 6) and a plurality of carriage bushings 44, for example, or alternately may be cast or molded as a single piece.

An elongated handle 20 is pivotally connected at a distal end 21 thereof proximate the forward side 110 of the carriage 12, preferably by a pivot bolt 41, a cotter pin (not shown), or the like. The handle 20 is pivotally, and preferably selectively, attached to the bar body 10, preferably with a fulcrum pin 52, a cotter pin (not shown), or the like, that is adapted for selectable engagement with the bar body 10. Such a fulcrum pin 52 may be a detent pin, for example, that includes a detent button (not shown) that must be pressed to remove the pin 52.

In such an embodiment, the handle 20 includes a slotted aperture 23 therein for slidably receiving the fulcrum pin 52. Preferably the distal end 21 of the handle 20 terminates in a pair of handle fork plates 15, each of which is pivotally fixed to the pivot bolt 41 of the carriage 12, and each of which includes the slotted aperture 23 therein for slidably receiving the fulcrum pin 52. The fulcrum pin 52 is preferably selectively engageable with any of the apertures 150 of the bar body 10, such that moving a proximal side 19 of the handle 20 upwards causes the distal end 21 of the handle 21 to pivot around the fulcrum pin 52 and move downward, forcing the carriage 12 to slide downward on the bar body 10. The handle 20 is preferably made from a rigid metal tubing, metal rod, or plastic material that is suitably strong and durable.

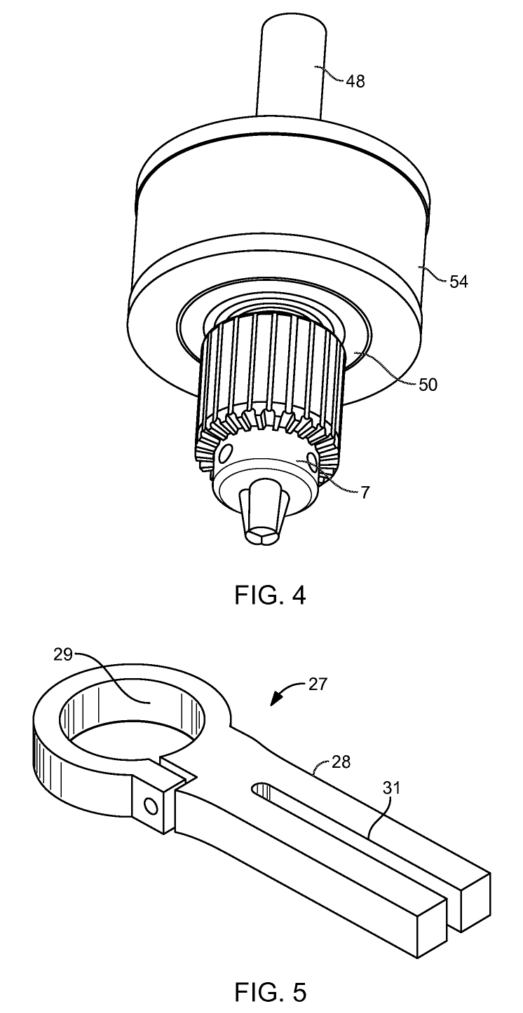

As illustrated in FIGS. 4 and 5, the drill clamping means 27 may include a drill shaft 48 rotatably fixed with a bearing 50 and a bearing block 54. A chuck 7 of the drill 6 may be removed from the drill 6 and engaged with the shaft 48 and the bearing 50. The shaft 48 may then be engaged with the drill 6 in place of the chuck 7. As such, the apparatus 10 may be used with the vast majority of available power drills on the market, either by clamping directly to the drill 6 or by utilizing the bearing block 54.

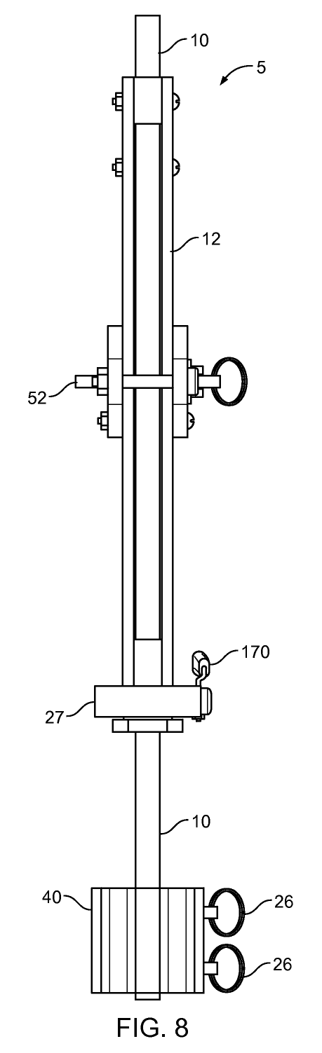

The clamping means 27 further includes a bracket 28 having an aperture 29, or a C-shaped clamp (not shown), cam-lock type fasteners 170 (FIGS. 7 and 8), or other clamping means, for selectively receiving the bearing block 54 fixedly therein. Further, the clamping means 27 includes a slot 31 for receiving a fixing means 22, such as a fastening knob 160 having a threaded shaft and adapted to fix the bracket 28 to a threaded receiving aperture 35 in the lower side of the carriage 12. The clamping means 27 may alternately be a cam lever lock 24 (FIG. 3), other clamp (not shown), or the like.

The spacer block 30 (FIG. 6) is preferably a rigid metal or plastic material that may be fixed proximate the lower side 11 of the carriage 12. The spacer block 30 preferably includes the threaded receiving aperture 35. The spacer block 30 may be fixed to the carriage 12, such as between the carriage plates 13, through fastening apertures 33 thereof by at least one mechanical fastener 32 (FIG. 3).

A foot means 40 is fixed to the bar body 10 with a bar body attachment means 43. The foot means 40 is preferably a rigid Y-shaped member 41, but may take other shapes as desired, extending away from the distal side 130 of the bar body 10. The bar body attachment means 43 of the foot means 40 is preferably at least two selectively engageable pins 26, cotter pins (not shown), bolts and nuts (not shown), or the like, adapted to traverse the Y-shaped member 41 and any two adjacent apertures 150 of the bar body 10. As such, the Y-shaped member 41 is selectively locked to, and at fixed at a predetermined angle with, the bar body 10.

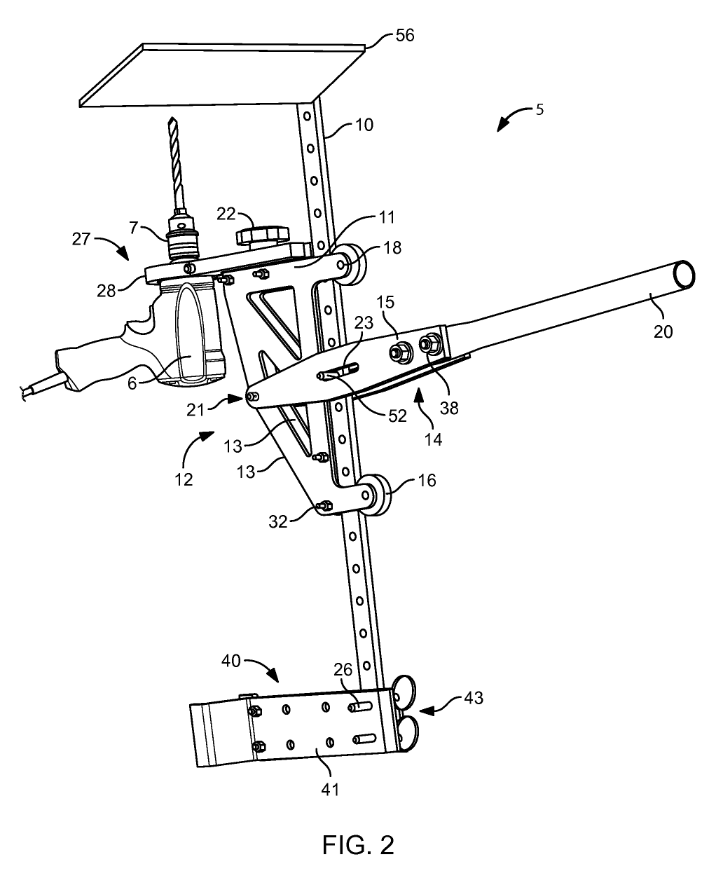

In use, with the drill 6 fixed to the drill clamping means 27 and with the workpiece 56 braced against the foot means 40, the carriage 12 can be moved toward the workpiece 56 and pivotally secured to the bar body 10, such as with the fulcrum pin 52. The proximal end 19 of the handle 20 is then moved upward to force the drill 6 downward into the workpiece 56 to drill the workpiece 56. Alternately, the carriage 12 may be removed from the bar body 10, inverted, and re-engaged with the bar body 10, such that the drill 6 is pointing upward in order to drill a workpiece in an upward direction (FIG. 2). As such, the proximal end 19 of the handle 20 may be moved downward to force the drill 6 upward into the workpiece 56.

Additional accessories may be included to aid drilling the workpiece 56 in various situations. For example, alternate drill clamping means 27 may be included, such as a strap having a cam lock fastener (not shown), or other mechanical fasteners that hold the drill 6 fixedly in place. Further, various means may be used for holding the foot means 40 to a surface, such as the workpiece 56 or other support surface. For instance, the foot means 40 may be held to the workpiece 56 by using a pair of suction cups that suspend a holding bar (not shown) above the workpiece 56 surface. As such, the foot means 40 may be placed under such a holding bar to secure the apparatus 10 against the workpiece 56 while drilling. Moreover, the apparatus is not limited to use with the drill 6. For example, the clamping means 27 may be used with any suitable tool, such as a router or sander.

While a particular form of the invention has been illustrated and described, it will be apparent that various modifications can be made without departing from the spirit and scope of the invention. For example, the specific shape of the carriage 12 and bar body 10 may be modified yet still maintain their sliding relationship. Accordingly, it is not intended that the invention be limited, except as by the appended claims.

What is claimed is:

1. A leveraging apparatus for a drill for drilling a workpiece, comprising:
an elongated, rigid bar body;
a carriage adapted to slidably receive the bar body proximate a rear side and having a forward side and a lower side for mounting with a drill clamping means;
a handle pivotally connected at a distal end thereof proximate the forward side of the carriage and pivotally and selectively attached to the bar body; and
a foot means fixed to the bar body with a bar body attachment means;
whereby with the drill fixed to the drill clamping means and the workpiece braced against the foot means, the carriage can be moved toward the workpiece and pivotally secured to the bar body, the handle then being moved to force the drill into the workpiece to drill the workpiece.

2. The apparatus of claim 1 wherein the elongated bar body has at least a proximal side, a distal side, and two lateral sides, the lateral sides both having a plurality of attachment apertures therethrough.

3. The apparatus of claim 1 wherein the carriage is adapted to slidably receive the bar body between at least two rollers each rotationally fixed proximate the rear side of the carriage.

4. The apparatus of claim 3 wherein the carriage is comprises of a pair of carriage plates for capturing the bar body and each roller therebetween.

5. The apparatus of claim 1 wherein the handle is pivotally connected proximate the forward side of the carriage by a pivot bolt.

6. The apparatus of claim 1 wherein the distal end of the handle terminates at a handle fork, the handle fork including a pair of handle fork plates each pivotally fixed to the pivot bolt of the carriage.

7. The apparatus of claim 6 wherein each handle fork includes a slotted aperture therein for receiving a fulcrum pin adapted for selectable engagement with the bar body.

8. The apparatus of claim 7 wherein the bar body includes a plurality of apertures through each lateral side thereof, and wherein the fulcrum pin is adapted for selectable engagement with any of the apertures of the bar body, such that moving the handle causes the handle to pivot around the fulcrum pin to move the carriage along the bar body.

9. The apparatus of claim 1 wherein the drill clamping means is a drill shaft rotatably fixed with a bearing and a bearing block, a chuck of the drill being engaged with the shaft and the bearing, the clamping means including a bracket having an aperture for selectively receiving the bearing block fixedly therein, and a slot for receiving a clamping means adapted to selectively fix the bracket to the lower side of the carriage.

10. The apparatus of claim 9 wherein the clamping means is a fastening knob and threaded shaft adapted to fix the bracket to a threaded receiving aperture in the lower side of the carriage.

11. The apparatus of claim 1 wherein the foot means is a rigid Y-shaped member extending away from the distal side of the bar body, and wherein the bar body attachment means thereof is at least two selectively engageable pins adapted to traverse the Y-shaped member and any two adjacent apertures of the bar body, such that the Y-shaped member is selectively locked to, and fixed at a predetermined angle with, the bar body.
